(19) United States
(12) Patent Application Publication
(10) Pub. No.: US 2005/0272283 A1
(43) Pub. Date: Dec. 8, 2005

(54) Board grounded memory card connector

(76) Inventor: Chia-Chen Chang, Hsin Chung City (TW)

Correspondence Address: MOLEX INCORPORATED, 2222 WELLINGTON COURT, LISLE, IL, 60532, US

(21) Appl. No.: 11/128,041

(22) Filed: May 12, 2005

(30) Foreign Application Priority Data
May 14, 2004 (TW) 93207509

(51) Int. Cl. H01R 13/648

(52) U.S. Cl. 439/92

(57) ABSTRACT

A memory card connector is provided for mounting on a printed circuit board. The connector includes a metal housing having a top wall and a pair of side walls defining a receiving space therebetween for receiving a memory card inserted into the receiving space through an insert opening at a front end of the housing. At least one grounding portion projects outwardly from one of the side walls and includes a base plate for surface connection to a ground pad on the printed circuit board. The grounding portion includes a positioning tab projecting downwardly from the base plate for insertion into a positioning hole in the printed circuit board to properly position the base plate on the ground pad on the circuit board.

### FIELD OF THE INVENTION

This invention generally relates to the art of electrical connectors and, particularly, to a memory card connector for mounting on a printed circuit board and grounded to ground pads or traces on the board.

### BACKGROUND OF THE INVENTION

Memory cards are known in the art and contain intelligence in the form of a memory circuit or other electronic program. Some form of card reader reads the information or memory stored on the card. Such cards are used in many applications in today's electronic society, including video cameras, digital still cameras, smart phones, PDA's, music players, ATMs, cable television decoders, toys, games, PC adapters, multi-media cards and other electronic applications. Typically, a memory card includes a contact or terminal array for connection through a card connector to a card reader system and then to external equipment. The connector readily accommodates insertion and removal of the card to provide quick access to the information and program on the card. The card connector includes terminals for yieldingly engaging the contact array of the memory card.

The memory card connector often is mounted on a printed circuit board. The memory card, itself, writes or reads via the connector and can transmit between electrical appliances, such as a word processor, personal computer, personal data assistant or the like. With circuit board mounted connectors, the terminals of a connector include tail portions which are connected to appropriate circuit traces on the printed circuit board by various systems, such as surface mount technology where the tail portions are reflow soldered to the circuit traces. Through hole technology involves inserting the tail portions of the terminals into the holes in the printed circuit board for connection, as by soldering, to circuit traces on the board and/or in the holes.

FIG. 10 shows somewhat schematically a board mounted memory card connector, generally designated 12, for mounting on a printed circuit board according to the prior art and adapted for receiving existing memory cards. The connector includes a frame or housing, generally designated 14, having a front card-receiving end 16 and a rear end 18. The housing is molded of dielectric material such as plastic or the like and includes a pair of side walls 14a and 14b projecting forwardly from opposite ends of a rear terminal-mounting section 14c. A card-receiving space, generally designated 20, is formed between side walls 14a and 14b for receiving a memory card, generally designated 22, inserted into the connector in the direction of arrow “A”. A card eject mechanism, generally designated 24, is mounted on side wall 14b and includes a push rod 24a pivotally connected to an ejection rod 24b which is pivoted to the rear terminal-mounting section 14c of the housing at pivot point 26. After memory card 22 is inserted into the card-receiving space 20, the card can be ejected by pushing on rod 24a in the direction of arrow “B” which, in turn, pivots a distal end of ejection rod 24b in the direction of arrow “C” to at least partially eject the memory card from its fully connected position. Insertion of a memory card back into the connector restores the eject mechanism to its ejection condition as shown in full lines in FIG. 10.

Connector 12 is mounted on a printed circuit board (not shown) by aligning a plurality of through holes 28 in housing 14 with a corresponding number of securing holes in the circuit board. A plurality of locking elements 30 are inserted through holes 28 and are secured into the securing holes in the circuit board to lock housing 14 and, thereby, connector 12 to the board. During the mounting procedure, an operator generally aligns through holes 28 with the securing holes in the circuit board by visual inspection which renders the mounting operation difficult and time consuming. Even if the housing is provided with some form of positioning mechanisms, such as positioning posts and holes between the connector housing and the circuit board, these positioning mechanisms typically are at distances from through holes 28 and the securing holes in the circuit board and are not provided in close proximity thereto. Because of the accumulation of manufacturing tolerances, these distances sometimes render through holes 85 misaligned with the securing holes in the circuit board which results in problems not only in mounting efficiency but also in manufacturing precision control. The present invention is directed to solving these problems by providing a very accurate system for mounting a memory card connector on a printed circuit board and grounding the connector to the board.

### SUMMARY OF THE INVENTION

An object, therefore, of the invention is to provide a new and improved memory card connector of the character described for mounting on a printed circuit board.

In the exemplary embodiment of the invention, the connector includes a metal housing having a top wall and a pair of side walls defining a receiving space therebetween for receiving a memory card inserted into the receiving space through an insert opening at a front end of the housing. At least one grounding portion projects outwardly from one of the side walls and includes a base plate for surface connection to a ground pad on the printed circuit board. The grounding portion includes a positioning tab projecting downwardly from the base plate for insertion into a positioning hole in the printed circuit board to properly position the base plate on the ground pad on the circuit board.

The metal housing may be stamped and formed of sheet metal material. An insulating socket is provided at a rear end of the metal housing opposite the insert opening. A plurality of conductive terminals are mounted in the socket for electrical connection between the memory card and a plurality of circuit traces on the printed circuit board.

According to one aspect of the invention, the base plate of the grounding portion includes a through hole for receiving a fastener extending upwardly from the printed circuit board. The positioning tab projects downwardly near an edge of the through hole. The grounding portion includes a frame projecting upwardly from the base plate for accepting a fastener receiver for coupling to the fastener extending upwardly from the circuit board through the hole in the base plate. In the preferred embodiment, the fastener receiver includes an internally threaded hole for receiving an externally threaded fastener, and the frame includes means for capturing the fastener receiver and nonrotatably holding the receiver on top of the base plate.

According to other aspects or features of the invention, the metal housing includes at least one flexible grounding finger projecting inwardly from at least one of the side walls for engaging a ground contact on the memory card. The front end of the metal housing is wider than the rear end thereof, whereby the receiving space is generally L-shaped in a horizontal plane. The insulating socket is located in the narrower rear end of the metal housing. A card eject mechanism also is located in the narrower rear end of the metal housing.

Other objects, features and advantages of the invention will be apparent from the following detailed description taken in connection with the accompanying drawings.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1 is an exploded perspective view of a memory card connector according to the invention;

FIG. 2 is a top perspective view of the memory card connector in assembled condition, mounted on a printed circuit board and about to receive a memory card;

FIG. 3 is a bottom perspective view of the memory card connector lifted off of the printed circuit board;

FIG. 4 is an enlarged perspective view of the eject mechanism removed from the connector;

FIG. 5 is a top plan view of the connector, with the memory card in a “card-out” position;

FIG. 6 is a view similar to that of FIG. 5, with the memory card pushed inwardly;

FIG. 7 is a view similar to that of FIGS. 5 and 6, with the memory card in a “card-in” position;

FIG. 8 is a view similar to that of FIGS. 5-7, with the memory card being ejected;

FIG. 9 is an enlarged perspective view of one of the grounding portions of the metal shell, along with the fastener receiver held by the grounding portion; and

FIG. 10 is a top plan view of the prior art connector described in the Background, above.

### DETAILED DESCRIPTION OF THE PREFERRED EMBODIMENT

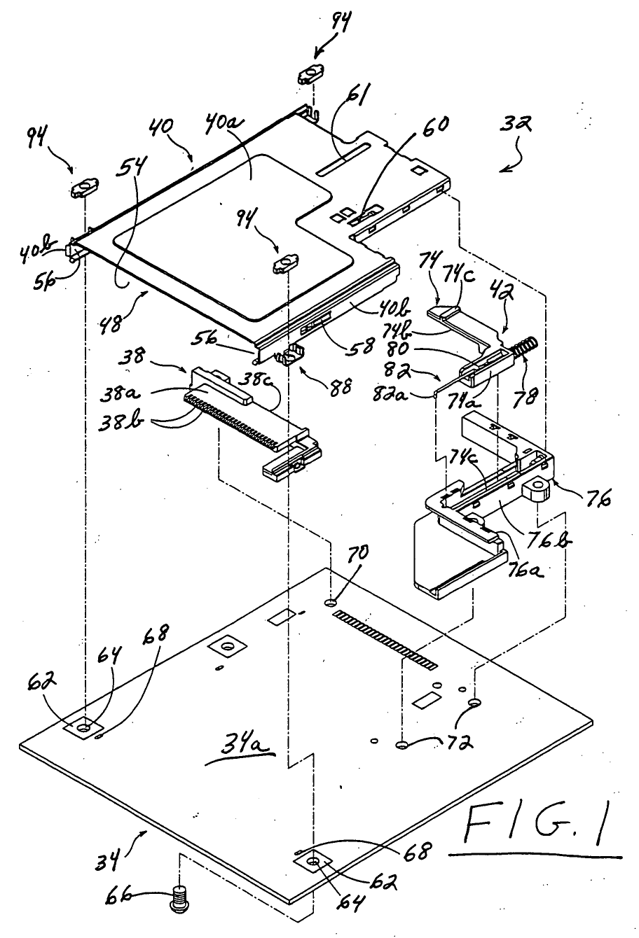

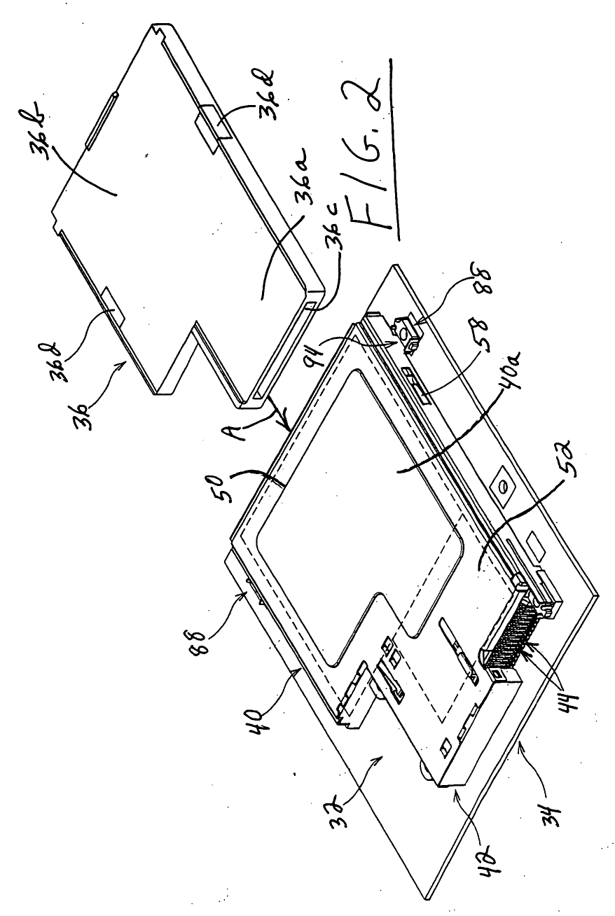

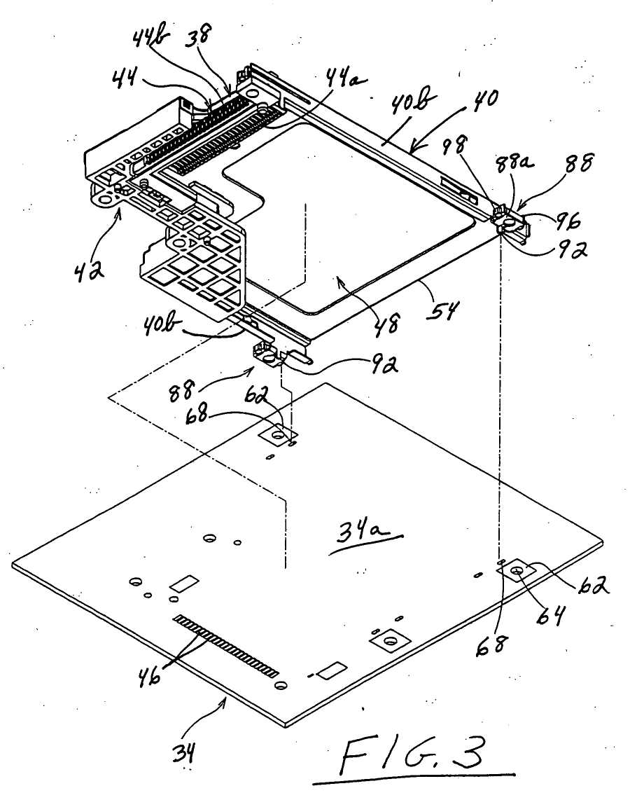

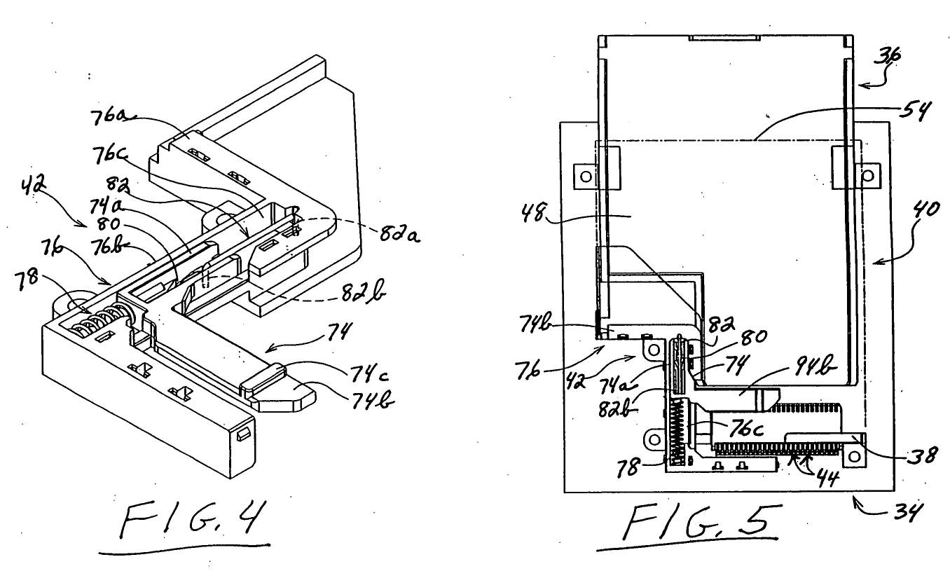

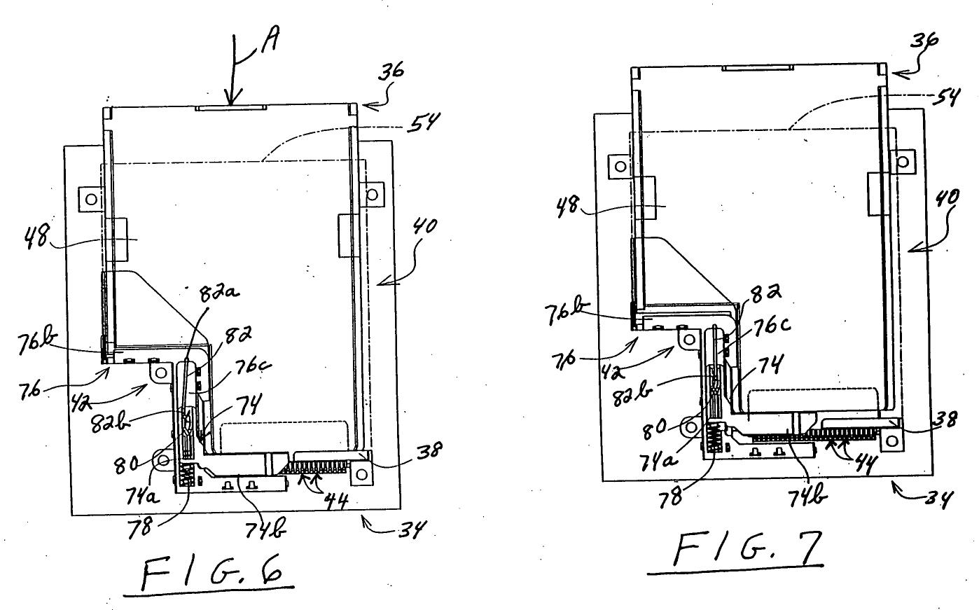

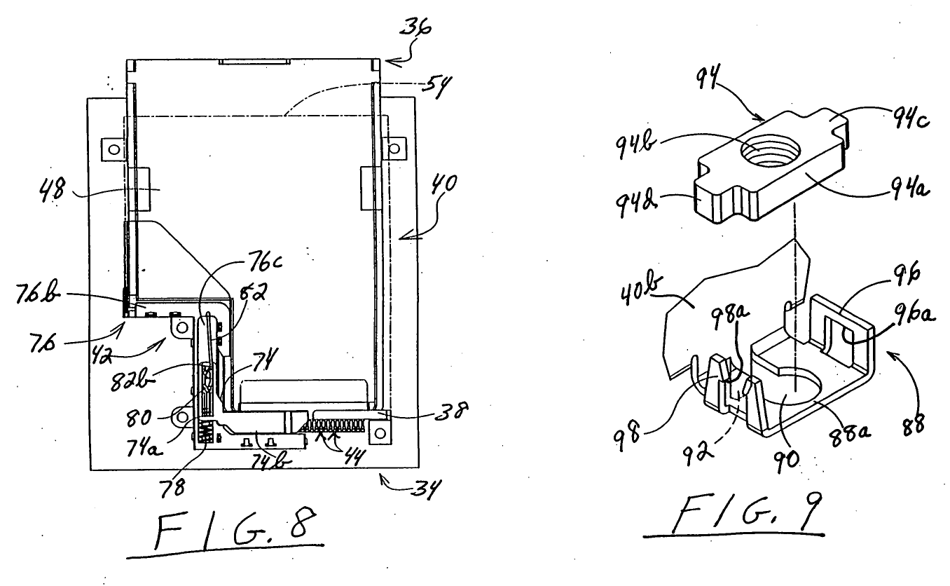

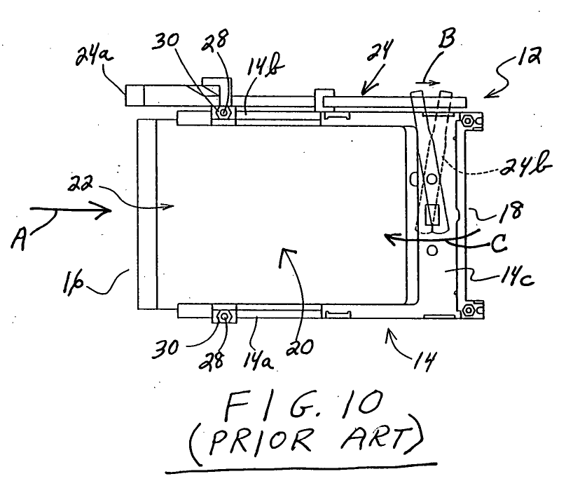

Referring to the drawings in greater detail, and first to FIGS. 1-3, the invention is embodied in a memory card connector, generally designated 32, for mounting on a printed circuit board, generally designated 34. The connector receives a memory card, generally designated 36, inserted into the connector in the direction of arrow “A” in FIG. 2. The connector includes an inner, insulating terminal socket, generally designated 38; an outer, shielding metal housing, generally designated 40; and an interior card eject mechanism, generally designated 42. A plurality of conductive terminals, generally designated 44 (FIGS. 2 and 3) are mounted in the terminal socket.

Terminal socket 38 is a one-piece structure unitarily molded of dielectric material such as plastic or the like. The socket includes a body 38a having a plurality of terminal-receiving passages 38b for receiving terminals 44. Body 38a has a front mating end 38c. As best seen in FIG. 3, when terminals 44 are mounted in terminal socket 38, the terminals have front contact ends 44a for engaging appropriate contacts on memory card 36. The terminals have rear tail portions 44b for connection, as by soldering, to a plurality of circuit traces 46 on a top surface 34a of printed circuit board 34.

Metal housing 40 is stamped and formed of conductive sheet metal material and includes a top wall 40a and a pair of side walls 40b which define a card-receiving space, generally designated 48, therebetween. The metal housing has a wider front end portion 50 (FIG. 2) and a narrower rear end portion 52, whereby card-receiving space 48 is generally L-shaped in a horizontal plane. A front insert opening 54 is formed at the front of the metal housing between side walls 40b thereof. Guide grooves 56 are formed in the insides of side walls 40b of the metal housing. A flexible grounding finger 58 is stamped and formed out of each side wall 40b and projects inwardly therefrom, for purposes to be described below. Finally, a spring finger 60 is stamped and formed out of top wall 40a of the metal housing, again for purposes described below. A guide groove 61 is formed in top wall 40a of the metal housing.

Before proceeding, and referring specifically to FIG. 2, memory card 36 is according to the ExpressCard specification. Consequently, the memory card includes a narrower leading end portion 36a and a wider trailing end portion 36b, which matches the L-shaped horizontal configuration of metal housing 40 as the memory card is inserted into the connector in the direction of arrow “A”. Leading end portion 36a of the memory card has a socket 36c within which a plurality of appropriate contacts (not visible in the drawings) are exposed for engaging contact portions 44a of terminals 44. A pair of ground contacts 36d are disposed at opposite sides of memory card 36 for engaging the flexible grounding fingers 58 of metal housing 40.

Printed circuit board 34 has a plurality of ground pads 62 on top surface 34a of the board. A securing hole 64 extends through the circuit board and through each ground pad 62 for receiving an externally threaded fastener 66 inserted upwardly through the hole and through the ground pad. A positioning hole or slot 68 extends into the circuit board immediately adjacent each ground pad 62. The circuit board includes a mounting hole 70 for mounting terminal socket 38 to the board, along with a pair of mounting holes 72 for mounting card eject mechanism 42 to the board.

Referring to FIG. 4 in conjunction with FIG. 1, card eject mechanism 42 is mounted in the narrower rear end portion 52 of metal housing 40, alongside terminal socket 38. The eject mechanism is a push/push type ejector and includes a cam slider, generally designated 74, slidably mounted on a base, generally designated 76, which is fixed to printed circuit board 34 by appropriate fasteners in mounting holes 72 in the board. Base 76 has a vertical portion 76a and a body portion 76b which extends in a front-to-rear direction relative to the connector. A sliding groove 76c is formed in the top of body portion 76b for receiving a sliding body portion 74a of cam slider 74. A coil spring 78 is positioned within the rear end of groove 76c of base 76 and abuts against body portion 74a of cam slider 74 to bias the cam slider forwardly in the eject direction. Cam slider 74 has a transverse portion 74b for engaging the leading edge of leading end portion 36a (FIG. 2) of the memory card. A guiding block 74c projects upwardly from transverse body portion 74b for riding in guide groove 61 in top wall 40a of the metal housing.

Still referring to FIG. 4 in conjunction with FIG. 1, cam slider 74 has a cam slot 80 in the top of body portion 74a which, as is known in the art, is generally heart-shaped to define the push/push movement of the memory card into and out of card-receiving space 48. A cam follower, generally designated 82, rides within cam slot 80 to control movement of cam slider 74 in its push/push action. Specifically, cam follower 82 is generally U-shaped and includes a hook portion or end 82a at one end thereof fixed to base 76, and a pivot portion or end 82b at the opposite end thereof which projects into and rides within cam slot 80.

FIGS. 5-8 show how card eject mechanism 42 operates sequentially in response to insertion of memory card 36 into card-receiving space 48 of connector 32. FIG. 5 basically shows the initial or “card-out” position of the memory card relative to the connector. In this position, cam slider 74 is biased forwardly by coil spring 78. The narrower leading end portion 36a (FIG. 2) of the memory card is in engagement with transverse body portion 74b of cam slider 74. Pivot end 82b of cam follower 82 is at the rear end of cam slot 80.

FIG. 6 shows memory card 36 pushed inwardly in the direction of arrow “A”, pushing cam slider 74 therewith. With hook end 82a of cam follower 82 fixing the cam follower to base 76, pivot end 82b of the cam follower rides forwardly within cam slot 80 to sort of an overrun position within the slot.

Upon removal of the pushing forces on memory card 36, coil spring 78 is effective to bias cam slider 74 and the memory card back outwardly, slightly to a locked position shown in FIG. 7 as defined by the interengagement of pivot end 82b of cam follower 82 within cam slot 80. The cam slider and memory card are stopped or locked at this point as is known in the art of such push/push eject mechanisms which include heart-shaped cam slots. In the locked position of the card as shown in FIG. 7, appropriate contacts on the card engage contact portions 44a of terminals 44. When it is desired to eject the memory card, the card is pushed back inwardly a second time, whereupon the locked condition of the card is released as pivot end 82b of cam follower 82 moves along the cam slot, and whereupon coil spring 78 is effective to eject the card back to its “card-out” position as shown in FIG. 8 and allow the card to be withdrawn from the card-receiving space 48 of the connector.

In order to mount metal housing 40 to printed circuit board 34 and to ground the metal housing to ground pads 62 on the board, a new and improved grounding portion, generally designated 88, is provided on the metal housing at one or more locations thereof. In the preferred embodiment, a grounding portion 88 projects outwardly from each side wall 40b of the metal housing. FIG. 9 shows one of the grounding portions 88 in detail.

Specifically, and referring to FIG. 9, each grounding portion 88 includes a base plate 88a projecting outwardly from a respective one of the side walls 40b of the metal housing. The base plate is connectable, as by soldering, to a respective one of the ground pads 62 (FIG. 3) on top surface 34a of printed circuit board 34. A through hole 90 is formed through base plate 88a. A positioning tab 92 is stamped and formed out of base plate 88a and projects downwardly immediately adjacent through hole 90. As stated above, a positioning slot 68 is formed through the circuit board immediately adjacent each ground pad 62. Therefore, metal housing 40 is very easily positionable onto the circuit board by inserting positioning tabs 92 of grounding portions 88 into positioning slots 68 in the circuit board. Through holes 90 in grounding portions 88, thereby, are precisely aligned with securing holes 64 in the circuit board. Externally threaded fasteners 66 (FIG. 1) then can be easily inserted upwardly through holes 64 in the circuit board, through ground pads 62 on the board and through holes 90 in base plates 88a of grounding portions 88.

Each grounding portion 88 receives and non-rotatably holds a fastener receiver, generally designated 94 and shown best in FIG. 9. Each fastener receiver 94 includes a block-like body portion 94a which has an internally threaded through hole 94b for threadingly receiving one of the externally threaded fasteners 66. First and second holding bosses 94c and 94d project outwardly from opposite ends of body 94a. Each grounding portion 88 includes frame means projecting upwardly from base plate 88a for accepting and non-rotatably capturing its respective fastener receiver 94. Specifically, the frame means includes a closed locking end 96 forming a hole 96a. A bifurcated, open locking end 98 projects upwardly from an opposite side of the base plate and forms a “snap mouth” 98a. The fastener receiver 94 is positioned in and non-rotatably captured on top of base plate 88a by first inserting holding boss 94c of the fastener receiver into hole 96a of closed locking end 96. The opposite holding boss 94d then is pushed downwardly into the snap mouth 98a of the open, bifurcated end 98 which snap-locks the fastener element in the grounding portion with the internally threaded hole 94b aligned with through hole 90 in base plate 88a which, in turn, is aligned with the respective securing hole 64 in the circuit board by means of positioning tab 92 having been inserted into positioning slot 68 in the board. One of the externally threaded fasteners 66 then can be inserted upwardly through the aligned holes and threaded into securing relationship within the internally threaded hole 94b of the respective fastener receiver 94. Base plate 88a is connected, as by reflow soldering, to its respective ground pad 62 on the circuit board.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

1. A memory card connector for mounting on a printed circuit board, comprising:
a metal housing having a top wall and a pair of side walls defining a receiving space therebetween for receiving a memory card inserted into the receiving space through an insert opening at a front end of the housing, and at least one grounding portion projecting outwardly from one of the side walls and including a base plate for surface connection to a ground pad on the printed circuit board and a positioning tab projecting downwardly from the base plate for insertion into a positioning hole in the printed circuit board to properly position the base plate on the ground pad on the circuit board;
an insulating socket at a rear end of the metal housing opposite said insert opening; and
a plurality of conductive terminals mounted in the insulating socket for electrical connection between the memory card and a plurality of circuit traces on the printed circuit board.

2. The memory card connector of claim 1 wherein the base plate of said grounding portion includes a through hole for receiving a fastener extending upwardly from the printed circuit board.

3. The memory card connector of claim 2 wherein said positioning tab projects downwardly from an edge of said through hole.

4. The memory card connector of claim 2 wherein said grounding portion includes a frame projecting upwardly from the base plate for accepting a fastener receiver for coupling to the fastener extending upwardly from the printed circuit board through the hole in the base plate.

5. The memory card connector of claim 4 wherein said fastener receiver includes an internally threaded hole for receiving an externally threaded fastener.

6. The memory card connector of claim 4 wherein said frame includes means for capturing the fastener receiver and holding the receiver on top of the base plate of the grounding portion.

7. The memory card connector of claim 1 wherein said metal housing includes at least one flexible grounding finger projecting inwardly from at least one of said side walls for engaging a ground contact on the memory card.

8. The memory card connector of claim 1 wherein the front end of said metal housing is wider than the rear end thereof whereby said receiving space is generally L-shaped in a horizontal plane.

9. The memory card connector of claim 8 wherein said insulating socket is located in the narrower rear end of the metal housing.

10. The memory card connector of claim 8, including a card eject mechanism located in the narrower rear end of the metal housing.

11. The memory card connector of claim 1 wherein said metal housing is stamped and formed of conductive sheet metal material.

12. The memory card connector of claim 1, including at least one of said grounding portions projecting outwardly from each of said side walls of the metal housing.

13. A memory card connector for mounting on a printed circuit board, comprising:
a metal housing stamped and formed of conductive sheet metal material and having a top wall and a pair of side walls defining a receiving space therebetween for receiving a memory card inserted into the receiving space through an insert opening at a front end of the housing, and at least one grounding portion projecting outwardly from one of the side walls and including
a base plate for surface connection to a ground pad on the printed circuit board,
a positioning tab projecting downwardly from the base plate for insertion into a positioning hole in the printed circuit board to properly position the base plate on the ground pad on the circuit board,
a through hole in the base plate for receiving a fastener extending upwardly from the printed circuit board,
a frame projecting upwardly from the base plate for accepting a fastener receiver for coupling to the fastener extending upwardly from the printed circuit board through the hole in the base plate,
said fastener receiver including an internally threaded hole for receiving an externally threaded fastener, and
said frame including means for non-rotatably capturing the fastener receiver and holding the receiver on top of the base plate;
an insulating socket at a rear end of the metal housing opposite said insert opening; and
a plurality of conductive terminals mounted in the insulating socket for electrical connection between the memory card and a plurality of circuit traces on the printed circuit board.

14. The memory card connector of claim 13 wherein said positioning tab projects downwardly from an edge of the through hole in the base plate of said grounding portion.

15. The memory card connector of claim 13 wherein said metal housing includes at least one flexible grounding finger projecting inwardly from at least one of said side walls for engaging a ground contact on the memory card.

16. The memory card connector of claim 13 wherein the front end of said metal housing is wider than the rear end thereof whereby said receiving space is generally L-shaped in a horizontal plane.

17. The memory card connector of claim 16 wherein said insulating socket is located in the narrower rear end of the metal housing.

18. The memory card connector of claim 16, including a card eject mechanism located in the narrower rear end of the metal housing.

19. The memory card connector of claim 13, including at least one of said grounding portions projecting outwardly from each of said side walls of the metal housing.

20. A memory card connector for mounting on a printed circuit board, comprising:
a metal housing stamped and formed of conductive sheet metal material and having a top wall and a pair of side walls defining a receiving space therebetween for receiving a memory card inserted into the receiving space through an insert opening at a front end of the housing, and at least one grounding portion projecting outwardly from one of the side walls and including a base plate for surface connection to a ground pad on the printed circuit board and a positioning tab projecting downwardly from the base plate for insertion into a positioning hole in the printed circuit board to properly position the base plate on the ground pad on the circuit board, the front end of the metal housing being wider than a rear end thereof whereby said receiving space is generally L-shaped in a plane generally parallel to the top wall of the metal housing;
an insulating socket disposed in the narrower rear end of the metal housing opposite said insert opening;
a plurality of conductive terminals mounted in the insulating socket for electrical connection between the memory card and a plurality of circuit traces on the printed circuit board; and
a card eject mechanism locating in the narrower rear end of the metal housing.

21. The memory card connector of claim 20, including at least one of said grounding portions projecting outwardly from each of said side walls of the metal housing.
